(19) United States
(12) Patent Application Publication
(10) Pub. No.: US 2017/0122496 A1
(43) Pub. Date: May 4, 2017

(54) ADSORBENT-BASED PRESSURE STABILIZATION OF PRESSURE-REGULATED FLUID STORAGE AND DISPENSING VESSELS

(71) Applicant: ENTEGRIS, INC., Billerica, MA (US)

(72) Inventor: Chris Scannell, Middlebury, CT (US)

(21) Appl. No.: 15/317,821

(22) PCT Filed: Jun. 11, 2015
(86) PCT No.: PCT/US2015/035435

§ 371 Date: Dec. 9, 2016

Related U.S. Application Data
(60) Provisional application No. 62/011,954, filed on Jun. 13, 2014.

(51) Int. Cl. F17C 13/04

(52) U.S. Cl. CPC F17C 13/04; F17C 2205/0329; F17C 2205/0338; F17C 2205/0391; F17C 2260/02; F17C 2270/0518

(57) ABSTRACT

A fluid supply package is described, including a pressure-regulated fluid storage and dispensing vessel comprising a fluid dispensing flow path, and adsorbent disposed in the flow path or in fluid communication therewith to reversibly adsorb fluid from the flow path for pressure stabilization of fluid dispensed from the vessel. A corresponding method is disclosed, of stabilizing fluid pressure during dispensing of fluid through a fluid flow path in a fluid supply package, by contacting the fluid in the fluid flow path with an adsorbent on which the fluid is reversibly adsorbable during the dispensing of fluid. Such approach of using a pressure management adsorbent stabilizes fluid pressure during fluid dispensing, and combats pressure oscillations that may occur during initiation or subsequent performance of fluid dispensing.

### CROSS-REFERENCE TO RELATED APPLICATION

This application claims the benefit of priority under the provisions of 35 U.S.C. §119 of U.S. Provisional Patent Application No. 62/011,954 filed Jun. 13, 2014. The disclosure of U.S. Provisional Patent Application No. 62/011,954 is hereby incorporated herein by reference in its entirety, for all purposes.

### FIELD

The present disclosure relates to pressure-regulated fluid storage and dispensing vessels comprising pressure regulators, and to pressure management of such vessels to combat pressure spiking and oscillation behavior upon initiation or subsequent performance of fluid dispensing operation, as well as related subassemblies and components, and methods of making and using such vessels, subassemblies, and components, and of supplying fluid in a pressure-managed manner.

### DESCRIPTION OF THE RELATED ART

In the field of semiconductor manufacturing, various fluid supply packages are used to provide process fluids for use in the manufacturing operation and in ancillary fluid-utilizing processes such as process vessel cleaning. As a result of safety and process efficiency considerations, fluid supply packages have been developed that utilize fluid storage and dispensing vessels in which pressure-regulating devices are provided in the interior volume of the vessel or the vessel valve head.

Examples of such fluid supply packages incorporating pressure-regulated vessels include the fluid supply packages commercially available from ATMI, Inc. (Danbury, Conn., USA) under the trademark VAC, the pressure-regulated vessel fluid supply packages commercially available from Praxair, Inc. under the trademark UPTIME, and fluid supply packages equipped with valve heads including regulator and flow control valve elements commercially available from L'Air Liquide (Paris, France) under the trademark SANIA.

In some instances, pressure-regulated vessels coupled to flow circuitry exhibit sudden pressure fluctuations upon initiation of fluid dispensing operation. This anomalous behavior is most frequently experienced as a pressure spike that is sensed by pressure sensing components in the flow circuitry. Such pressure spike behavior in previous semiconductor manufacturing operations has not been consequential, since this is a transient phenomenon that is quickly replaced by equilibrium flow (and thus the pressure spike is accommodated in the gradual progression of the process system to steady-state operating conditions), but recent trends in rapid beam tuning in ion implant applications have resulted in the process system being sensitive to this threshold fluctuation.

The occurrence of the pressure spike can cause flow circuitry components such as mass flow controllers to temporarily lose control, with the result that the process tool receiving the dispensed fluid receives out-of-specification fluid flow. In some instances, this may result in automatic process monitoring systems functioning to terminate operation, with consequent downtime adverse to the maintenance of manufacturing productivity. In other instances, the manufacturing tool may process the spike-associated sudden influx of fluid, with the result that out-of-specification product is produced.

Accordingly, the consequences of influent fluid pressure spikes in the fluid flow from pressure-regulated vessels can be severely detrimental to process efficiency and productivity.

### SUMMARY

The present disclosure relates to pressure management of pressure-regulated fluid storage and dispensing vessels that are susceptible to pressure-spiking behavior upon initiation or subsequent performance of fluid dispensing operation, and to fluid storage and dispensing vessels, subassemblies, and components thereof, as well as methods of making and using such vessels, subassemblies, and components, and of supplying fluid in a pressure regulated manner.

In one aspect, the disclosure relates to a fluid supply package comprising a pressure-regulated fluid storage and dispensing vessel comprising a fluid dispensing flow path, and adsorbent disposed in the flow path or in fluid communication therewith to reversibly adsorb fluid from the flow path for pressure stabilization of fluid dispensed from the vessel.

In another aspect, the disclosure relates to a fluid supply package comprising a pressure-regulated fluid storage and dispensing vessel, a valve head adapted for dispensing of fluid from the vessel at an outlet of the valve head, flow circuitry defining a flow path for flow of the fluid from an interior volume of the vessel through a pressure-regulating assembly in the flow path to the outlet of the valve head, and adsorbent disposed in the flow path or in fluid communication therewith to reversibly adsorb fluid from the flow path for pressure stabilization of fluid dispensed from the vessel.

A further aspect of the disclosure relates to a fluid supply package comprising a pressure-regulated vessel including a pressure regulator therein upstream of a discharge port of the vessel, and adsorbent that is arranged to suppress pressure oscillations in dispensing operation of the fluid supply package.

Another aspect of the disclosure relates to a fluid dispensing assembly for a fluid storage and dispensing vessel, said fluid dispensing assembly comprising: (i) a valve head including a dispensed fluid outlet port, (ii) at least one flow path passage member, and (iii) at least one pressure regulator device, set pressure valve, or vacuum- or pressure-activated check valve, wherein the fluid dispensing assembly components (i), (ii), and (iii) are coupled in the fluid dispensing assembly for flow of the fluid therethrough during dispensing of fluid from the vessel.

The present disclosure in a further aspect relates to a method of combating pressure oscillations in fluid dispensed from a pressure-regulated vessel, said method comprising contacting fluid in a fluid discharge path of the vessel with an adsorbent that is reversibly adsorptive for the fluid so that the adsorbent stabilizes fluid pressure during fluid dispensing.

In another aspect, the disclosure relates to a method of stabilizing fluid pressure during dispensing of fluid through a fluid flow path in a fluid supply package, said method comprising contacting the fluid in the fluid flow path with an adsorbent on which the fluid is reversibly adsorbable during said dispensing of fluid.

Other aspects, features and embodiments of the disclosure will be more fully apparent from the ensuing description and appended claims.

### BRIEF DESCRIPTION OF THE DRAWINGS

FIG. 1 is a schematic cross-sectional elevation view of a fluid supply package including a pressure-regulated fluid storage and dispensing vessel comprising a pressure management adsorbent disposed in the fluid flow path between a dual regulator assembly and the valve head of the vessel.

FIG. 2 is a schematic cross-sectional elevation view of a fluid supply package of a same general type as shown in FIG. 1, but wherein the pressure management adsorbent is disposed in the fluid flow path in the valve head, immediately upstream of the discharge port of the valve head.

FIG. 3 is a schematic elevation view, in partial cross-section, of a fluid supply package of a general type as schematically shown in FIG. 1, and wherein corresponding parts are correspondingly numbered for ease of reference.

FIG. 4 is a schematic cross-sectional view of a fluid supply package according to a further embodiment of the disclosure, wherein the pressure measurement adsorbent is disposed downstream from a vacuum actuated check valve.

FIG. 5 is a cross-sectional perspective view of a fluid dispensing assembly of a fluid supply package of the type shown in FIG. 1, wherein the pressure management adsorbent is disposed downstream of the upper pressure regulator in the assembly.

FIG. 6 is a cross-sectional perspective view of a fluid dispensing assembly of a fluid supply package of the type shown in FIG. 1, wherein the pressure management adsorbent is provided in an annular form providing a central bore passage through which fluid can flow and contact the adsorbent.

### DETAILED DESCRIPTION

The present disclosure relates to pressure management of pressure-regulated fluid storage and dispensing vessels that are susceptible to pressure-spiking behavior upon initiation or subsequent performance of fluid dispensing operation, and to fluid storage and dispensing vessels, subassemblies, and components thereof, as well as methods of making and using such vessels, subassemblies, and components, and of supplying fluid in a pressure regulated manner.

The present disclosure provides approaches for moderation of pressure swings during dispensing of fluid from pressure-regulated fluid supply packages in a simple, effective, and inexpensive manner.

As used herein, the term “pressure-regulated” in reference to fluid storage and dispensing vessels means that such vessels have at least one pressure regulator device, set pressure valve, or vacuum- or pressure-activated check valve disposed in an interior volume of the vessel and/or in a valve head of the vessel, with each such pressure regulator component being adapted so that it is responsive to fluid pressure in the fluid flow path immediately downstream of the pressure regulator component, and opens to enable fluid flow at a specific downstream reduced pressure condition in relation to the higher fluid pressure upstream of the pressure regulator component, and subsequent to such opening operates to maintain the pressure of fluid discharged from the vessel at a specific, or “set point,” pressure level.

As previously described in the background section hereof, pressure-regulated vessels have been found to occasionally (or sporadically) exhibit sudden pressure fluctuations upon initiation of fluid dispensing operation when coupled to flow circuitry that subjects pressure regulator device(s) in the vessel to pressure conditions intended to open the pressure regulator device(s) to permit fluid flow therethrough. Such sudden pressure fluctuations constitute anomalous flow behavior that can severely and adversely impact fluid delivery and process monitoring operations associated with the pressure-regulated vessel. In many instances, pressure-regulated fluid storage and dispensing vessels have exhibited pressure spikes that exceed the capability of mass flow controller devices utilized in the fluid delivery line coupled to the vessel, to maintain steady state flow conditions. The result is flow fluctuation upon start-up of delivery of fluid or restart of such fluid delivery operation, before equilibrium flow conditions can be achieved. Previously, this anomaly if present was unnoticed or inconsequential, but recent trends in high precision monitoring and control systems utilized in fluid-dispensing applications, e.g., in rapid beam tuning for ion implantation tools, has resulted in sensitivity of the process system to such fluctuation.

Although the pressure management adsorbent approach of the present disclosure is described herein primarily in application to combating rapid pressure fluctuations or oscillations occurring at the inception of fluid dispensing from a fluid supply package comprising a pressure-regulated vessel, it will be recognized that such pressure management adsorbent approach is likewise applicable to combat pressure spikes, fluctuations, oscillations and other anomalous flow behavior that may take place during the subsequent dispensing operation.

The present disclosure further contemplates methodologies for at least partially attenuating pressure-spiking behavior of fluid dispensed from a pressure-regulated fluid storage and dispensing vessel of a fluid supply package, comprising use of pressure management adsorbent, as herein described.

In one aspect, the disclosure relates to a fluid supply package comprising a pressure-regulated fluid storage and dispensing vessel comprising a fluid dispensing flow path, and adsorbent disposed in the flow path or in fluid communication therewith to reversibly adsorb fluid from the flow path for pressure stabilization of fluid dispensed from the vessel. Such fluid dispensing flow path may contain at least one pressure regulator device, set pressure valve, or vacuum- or pressure-activated check valve. In various embodiments, the fluid dispensing flow path contains two pressure regulator devices in series. Such pressure regulator devices may be of a type including a poppet valve element in a pressure-responsive mechanism. In other embodiments, the fluid dispensing flow path contains a vacuum-activated check valve, and a capillary flow restrictor may be provided upstream of such vacuum-activated check valve.

The above-described fluid supply package may be adapted to dispense fluid at subatmospheric pressure, e.g., by provision of a pressure regulator device having a subatmospheric pressure set point.

In one embodiment, the fluid supply package comprises a pressure-regulated vessel including a pressure regulator therein upstream of a discharge port of the vessel, and adsorbent that is arranged to suppress pressure oscillations in dispensing operation of the fluid supply package.

In other embodiments, the disclosure relates to a fluid supply package comprising a pressure-regulated fluid storage and dispensing vessel, a valve head adapted for dispensing of fluid from the vessel at an outlet of the valve head, flow circuitry defining a flow path for flow of the fluid from an interior volume of the vessel through a pressure-regulating assembly in the flow path to the outlet of the valve head, and adsorbent disposed in the flow path or in fluid communication therewith to reversibly adsorb fluid from the flow path to combat pressure oscillations in dispensing of the fluid from the vessel.

The pressure-regulating assembly may comprise a pressure regulator device, set pressure valve, or vacuum/pressure activated check valve disposed in an interior volume of the vessel and/or in a valve head of the vessel. The pressure-regulating assembly in specific implementations is responsive to downstream pressure so as to enable fluid flow for dispensing from the associated fluid supply package when pressure at an outlet of the package is below a predetermined level, and to prevent fluid flow when pressure is above such predetermined level.

The pressure regulator may for example comprise a poppet or other valve element in a pressure-responsive mechanism. In the fluid supply package, the pressure-regulated vessel may comprise a series arrangement of pressure regulators in the interior volume of the vessel, e.g., two or more regulators in series. The set point of the pressure regulators may have any suitable value, and in various embodiments the pressure regulator immediately upstream of the discharge port may have a subatmospheric pressure set point.

The disclosure in another aspect relates to a method of combating pressure oscillations in fluid dispensed from a pressure-regulated vessel, such method comprising contacting fluid in a fluid discharge path of the vessel with an adsorbent that is reversibly adsorptive for the fluid so that the adsorbent moderates pressure oscillations during fluid dispensing, in relation to fluid dispensing in the absence of such adsorbent.

The pressure management adsorbent utilized in the broad practice of the present disclosure may be of any suitable type, and may for example comprise silica, alumina, aluminosilicates, molecular sieves, carbon, macroreticulate polymers and copolymers, etc. In embodiments, the pressure management adsorbent may comprise carbon, e.g., a nanoporous carbon adsorbent having porosity of suitable character for the reversible adsorption of the fluid that is stored in and dispensed from the fluid storage and dispensing vessel in which such adsorbent is deployed.

The adsorbent may be a solid-phase physical adsorbent that is provided in a suitable form, e.g., a particulate or granular form, or a powder form, or a monolithic form. As used herein, “monolithic” means that the solid-phase physical adsorbent is in a unitary or block-like form, e.g., in the form of blocks, bricks, discs, boules, etc., in contrast to finely divided forms such as beads, particles, powders, granules, pellets, and the like. Thus, in a mass of multiple finely divided physical adsorbent elements, the void volume of the adsorbent is in major part interstitial, or inter-particle, in character, varying according to the dimensions, shape and packing density of the sorbent particles. By contrast, in a monolithic form, the void volume of the adsorbent is in form of porosity intrinsic to the adsorbent material and voids that may have been formed in the bulk sorbent body during its processing.

In embodiments, the solid-phase physical adsorbent may be in a monolithic form, comprising discs, cylinders, annular or tubular bodies, or other monolithic form of adsorbent, e.g., a nanoporous carbon adsorbent in the form of a cylinder, optionally with a fluid flow passage or passages therethrough, wherein the cylindrical form of the adsorbent enables it to be disposed in a fluid flow conduit, tubing, piping, or other flow passage having a circular cross-section section transverse to the fluid flow direction, as hereinafter described.

The monolithic adsorbent can be a carbon adsorbent that is formed as a pyrolysis product, as for example the pyrolysis product of an organic resin, and more generally can be formed from any suitable pyrolyzable material, such as for example polyvinylidene chloride, polyvinylidene fluoride, phenol-formaldehyde resins, polyfurfuryl alcohol, coconut shells, peanut shells, peach pits, olive stones, polyacrylonitrile, and polyacrylamide. In various embodiments, the adsorbent, e.g., a carbon adsorbent, has at least 20% of its porosity in pores with a diameter of less than 2 nanometers.

More generally, the adsorbent may comprise a carbon or other adsorbent, having at least one of the characteristics of: (i) a fill density measured for arsine gas at 25° C. and pressure of 650 torr that is greater than 400 grams arsine per liter of adsorbent; (ii) at least 30% of overall porosity of said adsorbent comprising slit-shaped pores having a size in a range of from about 0.3 to about 0.72 nanometer; (iii) at least 20% of the overall porosity comprising micropores of diameter<2 nanometers; and (iv) a bulk density of from about 0.80 to about 2.0 grams per cubic centimeter.

The pressure management adsorbent that is used in the fluid supply packages of the present disclosure has reversible adsorptive affinity for the fluid to be stored in and dispensed from the fluid supply package comprising such adsorbent.

The fluid in the fluid supply package that is reversibly sorptively interactive with the fluid being dispensed can be fluid of any suitable type, e.g., fluid having utility in manufacturing of semiconductor products, flat-panel displays, or solar panels. Examples of such fluids include hydrides, halides and organometallic gaseous reagents, and other fluids, e.g., silane, chlorosilane, disilane, trisilane, arsine, phosphine, phosgene, diborane, boron trichloride, boron trifluoride, diboron tetrafluoride, germane, ammonia, stibine, hydrogen sulfide, hydrogen selenide, hydrogen telluride, nitrous oxide, hydrogen cyanide, ethylene oxide, deuterated hydrides, halide (chlorine, bromine, fluorine, and iodine) compounds, germanium tetrafluoride, silicon tetrafluoride, hexafluorodisilane, hydrogen fluoride, hydrogen chloride, chlorine, fluorine, carbon monoxide, carbon dioxide, xenon, xenon difluoride, hydrogen, methane, halogenated silanes, halogenated disilanes, PF₃, PF₅, AsF₃, AsF₅, He, N₂, O₂, Ar, Kr, CF₄, CHF₃, CH₂F₂, CH₃F, NF₃, COF₂, gas mixtures including one or more of the foregoing, isotopically enriched gases, and gas mixtures including one or more isotopically enriched gases.

It will be appreciated that the type and amount of pressure management adsorbent that is used in the fluid supply package in accordance with the present disclosure may be widely varied in practice, depending on the specific type and pressure of fluid stored in the fluid supply package, the character of the flow path of the fluid being dispensed from such fluid supply package, the specific dispensing conditions, etc. the specific type and amount of pressure management adsorbent used when employed in a given fluid supply package nonetheless may be readily empirically determined by one of ordinary skill in the art, based on the disclosure herein.

The fluid supply package of the present disclosure may be constituted, with the fluid storage dispensing vessel comprising a fluid dispensing assembly defining the fluid dispensing flow path, the fluid dispensing assembly comprising (i) a valve head including a dispensed fluid outlet port, (ii) at least one flow path passage member, and (iii) at least one pressure regulator device, set pressure valve, or vacuum- or pressure-activated check valve, wherein the fluid dispensing assembly components (i), (ii), and (iii) are coupled in the fluid dispensing assembly for flow of the fluid therethrough during dispensing of fluid from the vessel.

The valve head may comprise a valve element that is selectively translatable between fully open and fully closed positions, such valve element being coupled with a valve actuator member for selective translation of the valve element. The valve actuator member may comprise a handwheel, or an automatic valve actuator such as a pneumatic valve actuator.

The fluid dispensing assembly may comprise at least one pressure regulator device, e.g., two pressure regulator devices in series arrangement with one another. Such pressure regulators regulator devices may comprise set point pressure regulators. The respective set points of the set point pressure regulators may be selected for a specific fluid dispensing operation. For example, a first upstream set point pressure regulator may have a superatmospheric pressure set point, and a second downstream set point pressure regulator may have a subatmospheric pressure set point.

The valve head in the fluid dispensing assembly of the fluid supply package may comprise a single port valve head, or alternatively a dual port valve head.

The at least one flow passage member in the fluid supply package may include tube or conduit passage members that are arranged in a flow circuit including the pressure-regulation components of the package, so as to define the flow path for the dispensing fluid, e.g., as including an inlet passage member into which fluid flows for flow through the flow path and the pressure-regulation components and ancillary components, such as particle filters. In various embodiments, the at least one flow path passage member includes an extension tube connecting the valve head and the at least one pressure regulator device, set pressure valve, or vacuum- or pressure-activated check valve, wherein the extension tube contains at least one of (A) the adsorbent, and (B) a particle filter. The extension tube may thus contain the adsorbent and/or particle filter.

In the fluid supply package, in specific embodiments, a particle filter may be provided upstream of the at least one pressure regulator device, set pressure valve, or vacuum- or pressure-activated check valve, in the fluid dispensing path. In a specific arrangement, the fluid dispensing assembly may comprise two set point pressure regulator devices in series arrangement with one another, with a first particle filter upstream of a first upstream one of the two set point pressure regulator devices, and a second particle filter that is downstream of a second downstream one of the two set point pressure regulator devices (as well as being downstream of the adsorbent).

In a particular implementation of the fluid supply package, the fluid dispensing assembly comprises two set point pressure regulator devices in series arrangement with one another, with a first upstream one of the two set point pressure regulator devices having a set point that is in a range of from about 20 psig to about 2500 psig (0.14 MPa to about 17.2 MPa), and a second downstream one of the two set point pressure regulator devices having a set point that is in a range of from about 1 torr (0.13 kPa) up to 2500 psig (17.2 MPa), and wherein the set point of the first upstream one of the two set point pressure regulator devices is greater than the set point of the second downstream one of the two set point pressure regulator devices.

In another specific implementation of the fluid supply package, the fluid dispensing assembly comprises two set point pressure regulator devices in series arrangement with one another, with a first upstream one of the two set point pressure regulator devices having a set point that is in a range of from about 100 psig (0.69 MPa) to about 1500 psig (10.3 MPa), and a second downstream one of the two set point pressure regulator devices having a set point that is in a range of from about 100 torr (13.3 kPa) to about 50 psig (0.34 MPa).

In yet another specific implementation of these fluid supply package, the fluid dispensing assembly comprises two set point pressure regulator devices in series arrangement with one another, with a first upstream one of the two set point pressure regulator devices having a set point that is at least twice the set point measured in same units of pressure measurement, of the second downstream one of the two set point pressure regulator devices.

In the fluid supply package, the two set point pressure regulator devices may be coaxially aligned with one another, with particle filters upstream and downstream of the series arrangement of the two set point pressure regulator devices, and/or with adsorbent disposed in the flow path downstream of the coaxially aligned set point pressure regulator devices.

Particle filters in the fluid supply package may be coated or impregnated with a chemical adsorbent that is selective for impurity species of fluid to be dispensed from the fluid supply and dispensing vessel.

The fluid storage dispensing vessel of the fluid supply package of the present disclosure may contain fluid at any suitable pressure, such as for example pressure in a range of from 1600 psig (11.03 MPa) to 2800 psig (19.3 MPa).

The adsorbent may be disposed in the flow path at any suitable location or at two or more locations, and in various embodiments the adsorbent may be disposed in the valve head, e.g., at the dispensed fluid outlet port. In fluid supply packages of the present disclosure, comprising a vacuum-actuated check valve coupled with an outlet tube in the flow path, the adsorbent may be disposed in the outlet tube, or in any other suitable location in the flow path of the fluid to be dispensed from the fluid storage and dispensing vessel.

In another aspect, the disclosure relates to a fluid supply package comprising a pressure-regulated fluid storage and dispensing vessel, a valve head adapted for dispensing of fluid from the vessel at an outlet of the valve head, flow circuitry defining a flow path for flow of the fluid from an interior volume of the vessel through a pressure-regulating assembly in the flow path to the outlet of the valve head, and adsorbent disposed in the flow path or in fluid communication therewith to reversibly adsorb fluid from the flow path for pressure stabilization of fluid dispensed from the vessel.

A further aspect of the disclosure relates to a fluid supply package comprising a pressure-regulated vessel including a pressure regulator therein upstream of a discharge port of the vessel, and adsorbent, e.g., a carbon adsorbent, which is arranged to suppress pressure oscillations in dispensing operation of the fluid supply package.

Another aspect of the disclosure relates to a fluid dispensing assembly for a fluid storage and dispensing vessel, said fluid dispensing assembly comprising: (i) a valve head including a dispensed fluid outlet port, (ii) at least one flow path passage member, and (iii) at least one pressure regulator device, set pressure valve, or vacuum- or pressure-activated check valve, wherein the fluid dispensing assembly components (i), (ii), and (iii) are coupled in the fluid dispensing assembly for flow of the fluid therethrough during dispensing of fluid from the vessel. The fluid dispensing assembly may be constituted, constructed, and arranged as variously described herein.

The present disclosure in a further aspect relates to a method of combating pressure oscillations in fluid dispensed from a pressure-regulated vessel, said method comprising contacting fluid in a fluid discharge path of the vessel with an adsorbent that is reversibly adsorptive for the fluid so that the adsorbent stabilizes fluid pressure during fluid dispensing.

In another aspect, the disclosure relates to a method of stabilizing fluid pressure during dispensing of fluid through a fluid flow path in a fluid supply package, said method comprising contacting the fluid in the fluid flow path with an adsorbent on which the fluid is reversibly adsorbable during said dispensing of fluid.

In such method, the fluid supply package may comprise a pressure-regulated fluid storage and dispensing vessel. The pressure-regulated fluid storage dispensing vessel may contain at least one pressure device, set pressure valve, or vacuum- or pressure-activated check valve. The method may be carried out with a pressure-regulated fluid storage and dispensing vessel containing two pressure regulator devices in series, or a pressure-regulated fluid storage and dispensing vessel containing a vacuum-activated check valve, e.g., optionally including a capillary flow restrictor upstream of such vacuum-activated check valve in the pressure-regulated fluid storage and dispensing vessel.

The adsorbent utilized in such method may be of any suitable type as described herein.

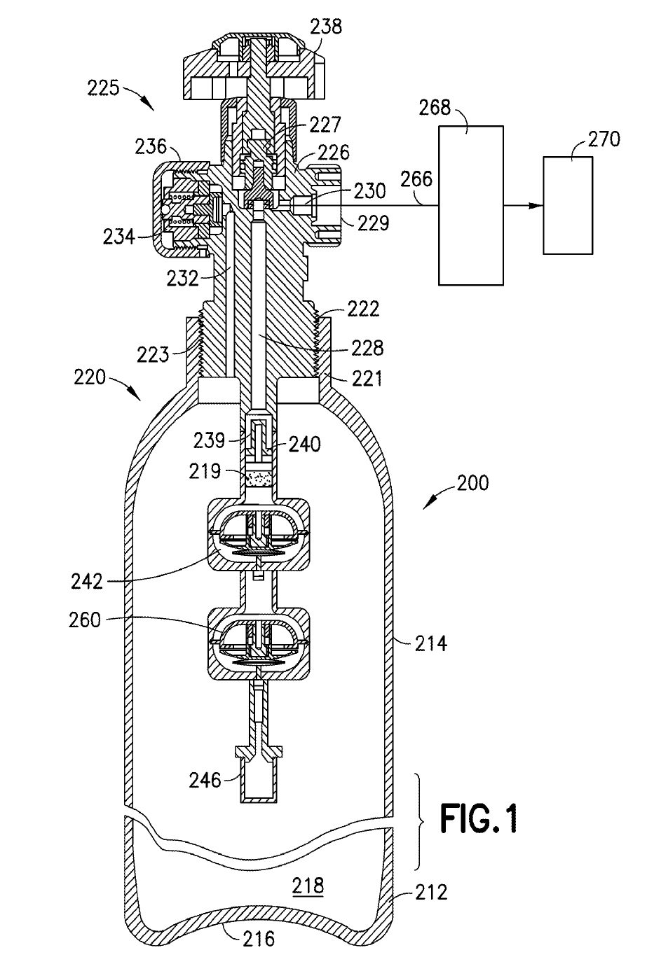

Referring now to the drawings, FIG. 1 is a schematic cross-sectional elevation view of an illustrative fluid supply package 200 including a pressure-regulated fluid storage and dispensing vessel to which the pressure management adsorbent approach of the present disclosure may be applied.

The fluid supply package 200 includes a fluid storage and dispensing vessel 212 comprising a cylindrical sidewall 214 and a floor 216 corporately enclosing the interior volume 218 of the vessel. The side wall and floor may be formed of any suitable material of construction, e.g., metal, gas-impermeable plastic, fiber-resin composite material, etc., as appropriate to the gas to be contained in the vessel, the end use environment of the apparatus, and the pressure levels to be maintained in the vessel in storage and dispensing use.

At its upper end 220, the vessel features a neck 221 defining a port opening 222 bounded by the inner wall 223 of the neck 221. The inner wall 223 may be threaded or otherwise complementarily configured to matably engage therein a valve head 225 including valve body 226 that may be complementarily threaded or otherwise configured for such engagement.

In such manner, the valve head 225 is engaged with the vessel 212 in a leak-tight manner, to hold gas therein in the interior volume 218 at the desired storage conditions.

The valve head body 226 is formed with a central vertical passage 228 therein for dispensing of gas deriving from fluid in the vessel 212. The central vertical passage 228 communicates with the fluid discharge passage 230 of the fluid discharge port 229, as shown.

The valve head body contains a valve element 227 that is coupled with the valve actuator 238 (hand wheel or pneumatic actuator), for selective manual or automated opening or closing of the valve. In this fashion, the valve actuator may be opened to flow gas through the central vertical passage 228 to the fluid discharge port 229, or alternatively the valve actuator may be physically closed, to terminate flow of fluid from the central vertical passage 228 to the fluid discharge port 229 during the dispensing operation.

The valve actuator thus can be any of various suitable types, e.g., manual actuators, pneumatic actuators, electromechanical actuators, etc., or any other suitable devices for opening and closing the valve in the valve head.

The valve element 227 is therefore arranged downstream of the regulator, so that fluid dispensed from the vessel flows through the regulator prior to flow through the flow control valve comprising valve element 227.

The valve head body 226 also contains a fill passage 232 formed therein to communicate at its upper end with a fill port 234. The fill port 234 is shown in the FIG. 1 drawing as capped by fill port cap 236, to protect the fill port from contamination or damage when the vessel has been filled and placed into use for the storage and dispensing of fluid from the contained fluid.

The fill passage at its lower end exits the valve head body 226 at a bottom surface thereof as shown. When the fill port 234 is coupled with a source of the gas to be contained in the vessel, the fluid can flow through the fill passage and into the interior volume 218 of the vessel 212.

Joined to the lower end of valve head body 226 is an extension tube 240, containing an upper particle filter 239 therein. Upper regulator 242 is mounted on the end of the extension tube 240. The upper regulator 242 is secured to the extension tube lower end in any suitable manner, as for example by providing internal threading in the lower end portion of the extension tube, with which the regulator 242 is threadably engageable.

Alternatively, the upper regulator may be joined to the lower end of the extension tube by compression fittings or other leak-tight vacuum and pressure fittings, or by being bonded thereto, e.g., by welding, brazing, soldering, melt-bonding, or by suitable mechanical joining means and/or methods, etc.

The upper regulator 242 is arranged in series relationship with a lower regulator 260, as shown. For such purpose, the upper and lower regulators may be threadably engageable with one another, by complementary threading comprising threading on the lower extension portion of the upper regulator 242, and threading that is matably engageable therewith on the upper extension portion of the lower regulator 260.

Alternatively, the upper and lower regulators may be joined to one another in any suitable manner, as for example by coupling or fitting means, by adhesive bonding, welding, brazing, soldering, etc., or the upper and lower regulators may be integrally constructed as components of a dual regulator assembly.

At its lower end, the lower regulator 260 is joined to high efficiency particle filter 246.

The high efficiency particle filter 246 serves to prevent contamination of the regulator elements and valve element 227 with particulates or other contaminating species that otherwise may be present in the fluid flowed through the regulators and valves in the operation of the apparatus.

The extension tube 240 has high efficiency particle filter 239 disposed therein, to provide particulate removal capability and ensure high gas purity of the dispensed fluid.

Preferably, the regulator has at least one particle filter in series flow relationship with it. Preferably, as shown in the FIG. 1 embodiment, the system includes a particle filter upstream of the regulator(s), as well as a particle filter downstream of the regulator(s), in the fluid flow path from the vessel interior volume 218 to the fluid discharge port 229.

Disposed in such fluid flow path, downstream of the upper regulator 242 and below the particle filter 239, is a mass of porous adsorbent 219, through which the fluid being dispensed in the fluid flow path passes for adsorptive contact with the adsorbent. Such adsorptive contact mediates fluid adsorption on and fluid desorption from the adsorbent, so that the adsorbent damps any pressure oscillations that may otherwise occur and propagate in the fluid during the fluid dispensing operation.

The valve head 225 in the FIG. 1 embodiment thus provides a two-port valve head assembly—one port is the gas fill port 234, and another port is the gas discharge port 229.

The pressure regulators in the FIG. 1 embodiment are each of a type including a diaphragm element coupled with a poppet-retaining wafer. The wafer in turn is connected to the stem of a poppet element, as part of a pressure sensing assembly that precisely controls outlet fluid pressure. A slight increase in outlet pressure above set point causes the pressure sensing assembly to contract, and a slight decrease in the outlet pressure causes the pressure sensing assembly to expand. The contraction or expansion serves to translate the poppet element to provide precise pressure control. The pressure sensing assembly has a set point that is pre-established or set for the given application of the fluid storage and dispensing system.

As illustrated, a gas discharge line 266, containing a flow control device 268 therein, is coupled with the discharge port 229. By this arrangement, the flow control device in the gas discharge line is opened to flow gas from the vessel 212 to the associated process facility 270 (e.g., a semiconductor manufacturing facility, flat-panel display manufacturing facility, a solar panel manufacturing facility, or other use facility), in the dispensing mode of the fluid supply package 200, when fluid from the storage and dispensing vessel is flowed through the upstream (lower) regulator 260 and then through the downstream (upper) regulator 242 and the pressure management adsorbent 219 to the discharge port 229 of the valve head. The flow control device 268 may be of any suitable type, and in various embodiments may comprise a mass flow controller.

The fluid dispensed in such manner will be at a pressure determined by the set point of the regulator 242, with the pressure management adsorbent serving to combat any rapid pressure swings or instabilities in the fluid flow stream that is being dispensed from the fluid supply package.

The respective set points of the regulator 260 and the regulator 242 in the FIG. 1 embodiment may be selected or preset at any suitable values to accommodate a specific desired end use application.

For example, the lower (upstream) regulator 260 may have a set point that is in a range of from about 20 psig to about 2500 psig (0.14 MPa to about 17.2 MPa). The upper (downstream) regulator 242 may have a set point that is above the pressure set point of the lower (upstream) regulator 260, e.g., in a range of from about 1 torr (0.13 kPa) up to 2500 psig (17.2 MPa).

In one illustrative embodiment, the lower (upstream) regulator 260 has a set point pressure value that is in the range of from about 100 psig (0.69 MPa) to about 1500 psig (10.3 MPa), while the upper (downstream) regulator 242 has a set point pressure value in the range of from about 100 torr (13.3 kPa) to about 50 psig (0.34 MPa), wherein the lower (upstream) pressure set point is above the set point of the upper (downstream) regulator.

Although the set points of the regulators in a serial regulator assembly may be established in any suitable ratio in relation to one another, in a two-regulator assembly such as that shown in FIG. 1, the upstream regulator in preferred practice advantageously has a pressure set point that is at least twice the set point value (measured in the same pressure units of measurement) of the downstream regulator.

In the FIG. 1 embodiment, the lower and upper regulators are coaxially aligned with one another to form a dispensing assembly having particulate filters on either end, with a pressure management adsorbent in the fluid flow path of such dispensing assembly. As a consequence of such arrangement, the fluid dispensed from the vessel 212 is of extremely high purity and stable pressure character.

As a further modification, the particulate filters may be coated or impregnated with a chemical adsorbent that is selective for impurity species present in the fluid to be dispensed (e.g., decomposition products deriving from reaction or degradation of the gas in the vessel). In this manner, the fluid flowing through the particulate filter is purified in situ along the flow path as it is being dispensed.

In one illustrative embodiment of a fluid storage and dispensing system of the type shown in FIG. 1, the vessel 212 is a 3AA 2015 DOT 2.2 liter cylinder. The high efficiency particle filter 246 is a GasShield™ PENTA™ point-of-use fluid filter, commercially available from Mott Corporation (Farmington, Conn.), having a sintered metal filtration medium in a housing of 316L VAR/electropolished stainless steel or nickel capable of greater than 99.9999999% removal of particles down to 0.003 micron diameter. The high efficiency particle filter 239 is a Mott standard 6610-1/4 in-line filter, commercially available from Mott Corporation (Farmington, Conn.). The regulators are HF series Swagelok® pressure regulators, with the upper (downstream) regulator 242 having a set point pressure in the range of from 100 Torr (13.3 kPa) to 100 psig (689.5 kPa), and the lower (upstream) regulator 260 having a set point pressure in the range of from 100 psig (689.5 kPa) to 1500 psig (10.3 MPa), and with the set point pressure of the lower (upstream) regulator 260 being at least twice the set point pressure of the upper (downstream) regulator 242. The pressure management adsorbent in such illustrative embodiment comprises a porous carbon adsorbent having porosity comprising pores of appropriate pore size and pore size distribution that are effective to combat pressure oscillations in the dispensing operation of the fluid storage and dispensing system.

In such specific embodiment, the upper (downstream) regulator 242 may have an inlet pressure of 100 psig (689.5 kPa) and outlet pressure of 500 torr (66.7 kPa), and the lower (upstream) regulator 260 may have an inlet pressure of 1500 psig (10.3 MPa) and outlet pressure of 100 psig (689.5 kPa).

The fluid in such fluid supply package may therefore be stored at substantial superatmospheric pressure to maximize inventory of the gas in the fluid storage and dispensing vessel of such package. In some embodiments, the fluid may be stored at pressure in a range of from 1600 psig (11.03 MPa) to 2800 psig (19.3 MPa) or higher.

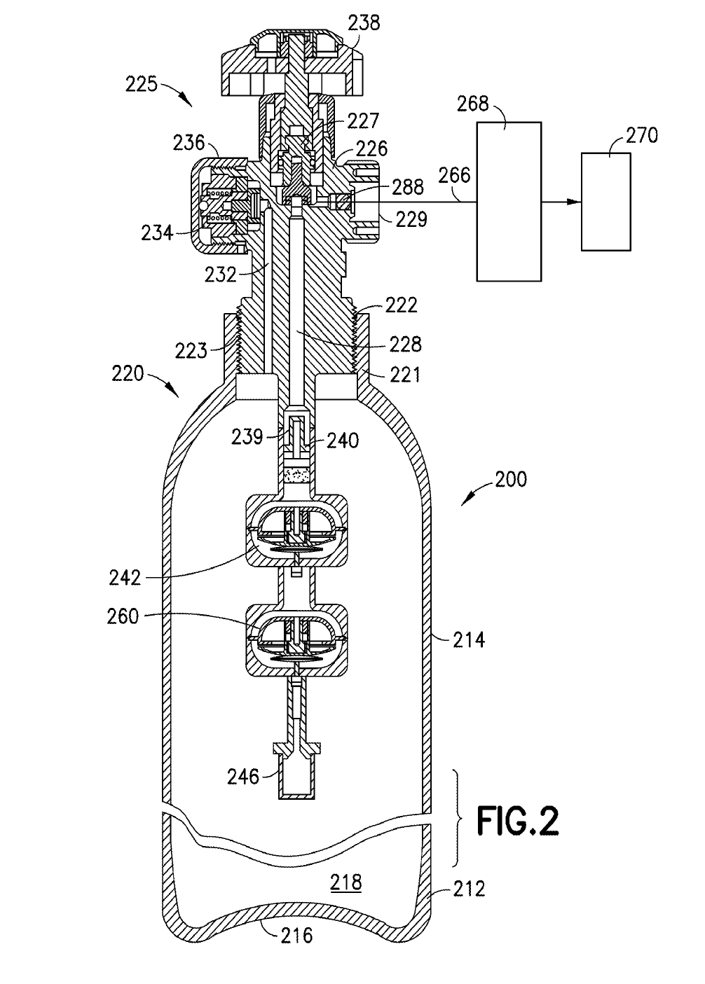

FIG. 2 is a schematic cross-sectional elevation view of a fluid supply package of a type as shown in FIG. 1, wherein all corresponding elements and features are correspondingly numbered for ease of reference, but wherein the valve head body 226 has been modified to dispose the pressure management adsorbent 288 in the fluid flow path in the valve head, immediately upstream of the fluid discharge port 229 of the valve head. In such manner, the pressure management porous adsorbent 288 is incorporated in the fluid discharge passage of the fluid supply package, to suppress pressure spikes or oscillation behavior on inception of or during dispensing operation. The porous adsorbent 288 may be in the form of a cylindrical body of adsorbent, e.g., porous carbon, which is adapted to be press-fit in the discharge port 229. Alternatively, the porous carbon adsorbent may be affixed or secured in the discharge port 229 in any suitable manner. For example, the porous carbon adsorbent may be in the form of granules or particles that are in a porous container such as a wire basket of small size that is bonded or mechanically secured to the inner wall of the discharge passage at the discharge port 229.

In alternative embodiments to the specific arrangements shown in FIGS. 1 and 2, the pressure management adsorbent may be disposed at any suitable location(s) in or along the dispensed fluid flow path for adsorptive contact with the fluid being dispensed. For example, the adsorbent may be disposed in the extension tube 240, the central vertical passage 228, or the fluid discharge passage 230 of the fluid discharge port 229, or in two or more of such locations, or in a compartment that is in fluid communication with the dispensed fluid flow path and contains the adsorbent, e.g., a compartment containing the adsorbent that is arranged in fluid flow communication with the extension tube 240, the central vertical passage 228, or the fluid discharge passage 230 of the fluid discharge port 229, or in two or more of such locations.

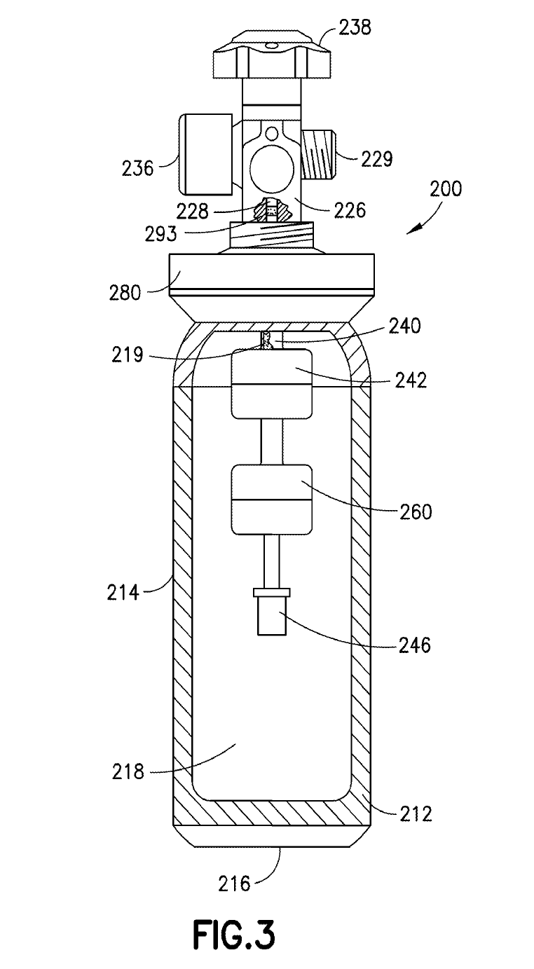

FIG. 3 is a schematic elevation view, in partial cross-section, of a fluid supply package of the general type schematically shown in FIG. 1, and wherein corresponding parts are correspondingly numbered for ease of reference. The FIG. 3 fluid supply package differs from that shown in FIG. 1, in the provision in the FIG. 3 package of a collar flange member 280 coupled to the neck of the vessel 212. The valve head body 226 in the FIG. 3 package is secured to the collar flange member 280. The FIG. 3 fluid supply package also differs from that shown in FIG. 1, in the provision in the FIG. 3 fluid supply package of a pressure management adsorbent 293 in the central vertical passage 228 of the valve head body 226, in addition to the provision (as in the FIG. 1 package) of a pressure management adsorbent 219 in the extension tube 240.

The adsorbent 219 in the FIG. 3 package may be of a same or alternatively of a different type in relation to adsorbent 293. For example, adsorbent 219 may comprise a carbon adsorbent having one or more of the following characteristics: (i) a fill density measured for arsine gas at 25° C. and pressure of 650 torr that is greater than 400 grams arsine per liter of adsorbent; (ii) at least 30% of overall porosity of said adsorbent comprising slit-shaped pores having a size in a range of from about 0.3 to about 0.72 nanometer; (iii) at least 20% of the overall porosity comprising micropores of diameter<2 nanometers; and (iv) a bulk density of from about 0.80 to about 2.0 grams per cubic centimeter. Adsorbent 293 may comprise a same adsorbent, or alternatively a different adsorbent, such as silica or aluminosilicate adsorbent.

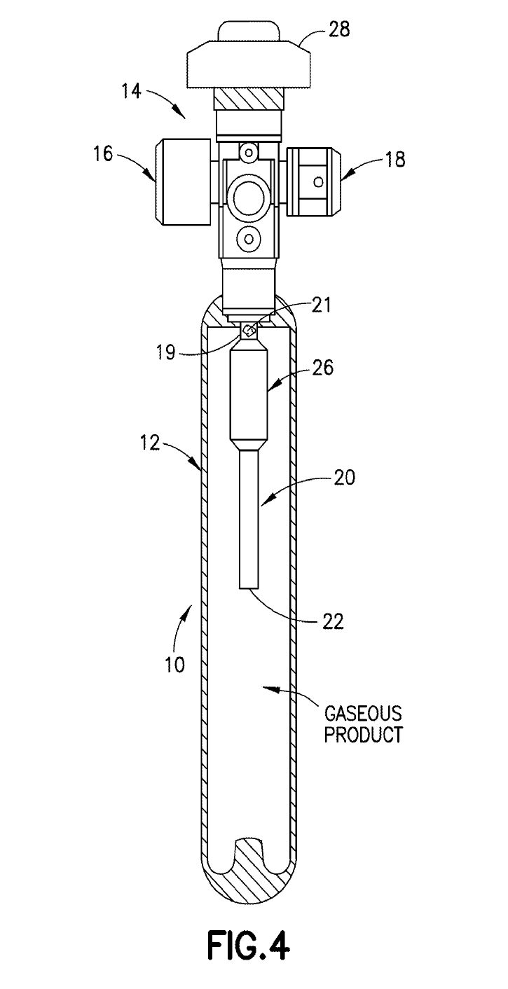

FIG. 4 is a schematic cross-sectional view of a fluid supply package for storage and dispensing of a fluid therefrom, according to a further embodiment to which the pressure management adsorbent approach of the present disclosure may be applied.

As illustrated in FIG. 4, a system 10 for the storage and delivery of fluid is depicted. System 10 includes high pressure cylinder or tank 12 containing fluid, e.g., boron trifluoride, in gaseous or partially gaseous phase. The compressed gas cylinder can be a conventional 500 cc cylinder, such as the one approved by the Department of Transportation 3AA cylinder, but is not limited thereto. A cylinder valve head 14 is threadably engaged at the top end of cylinder 12. The cylinder valve head 14 can be a dual-port 316 stainless steel valve, such as the one manufactured by Ceodeux, Inc. The dual-port valve cylinder head 14 has a tamper-resistant fill port 16, through which cylinder 12 is filled with product fluid. Upon filling, the user can draw product fluid from the cylinder through user port 18, which is a face-seal VCR™ port having an outlet opening ranging from about 0.25 to about 0.5 inch (0.635 cm to 1.27 cm) in diameter. The interior of the cylinder contains an internal flow restrictor 20 having an inlet 22. The flow restrictor 20 can comprise a capillary flow restrictor, e.g., comprising multiple capillary flow passages. Until exhausted, fluid flows into inlet 22, through the internal flow restrictor and a vacuum actuated check valve 26, along a fluid flow path, described in detail below, to user port 18.

Vacuum actuated check valve 26 contains a bellows chamber that automatically controls the discharge of fluid from the cylinder. The check valve 26 can be disposed in the port body of the dual-port valve, upstream of the dual-port valve, within the cylinder or partly in the dual-port valve and partly within the cylinder along the fluid flow path. As shown in the exemplary embodiment of FIG. 2, the vacuum actuated check valve is fully disposed inside cylinder 12, by affixing one portion of the check valve to the housing which is located along the fluid discharge path. A handle 28 at the top of dual-port valve allows manual control of the fluid along the fluid discharge path leading to user port 18. This type of fluid storage and dispensing system is described in U.S. Pat. Nos. 5,937,895, 6,007,609, 6,045,115, and 7,905,247, with the first three of such patents referencing a single port valve cylinder head. The disclosures of all such patents are incorporated herein by reference in their respective entireties.

The check valve 26 includes an outlet tube 19, in which is disposed an adsorbent 21 to moderate pressure spikes and other anomalous flow behavior during the dispensing operation. The adsorbent 21 may comprise a carbon adsorbent of the aforementioned type, or other adsorbent having sorptive affinity for the fluid stored in and dispensed from the system.

The FIG. 4 fluid supply package can be employed for sub-atmospheric pressure dopant gas delivery for ion implantation in a semiconductor manufacturing facility. Regardless of cylinder temperature, elevation or fill volume, the system in various embodiments is constructed and arranged so that it delivers product fluid only when a predetermined vacuum level, e.g., a vacuum level between 500-100 torr (66.6 kPa-13.3 kPa), is applied to the use port. Product fluid cannot flow from the fluid supply package without such vacuum, owing to the presence of the vacuum actuated check valve.

Fluid stored in and dispensed from the fluid supply package of the disclosure may be of any suitable type, and may for example comprise a fluid having utility in semiconductor manufacturing, manufacture of flat-panel displays, or manufacture of solar panels.

The fluid contained in the fluid storage and dispensing vessel may for example comprise a hydride fluid for semiconductor manufacturing operations. Examples of hydride fluids of such type include arsine, phosphine, stibine, silane, chlorosilane, diborane, germane, disilane, trisilane, methane, hydrogen selenide, hydrogen sulfide, and hydrogen. Other fluids useful in semiconductor manufacturing operations may be employed, including acid fluids such as hydrogen fluoride, boron trichloride, boron trifluoride, diboron tetrafluoride, hydrogen chloride, halogenated silanes (e.g., SiF₄) and disilanes (e.g., Si₂F₆), GeF₄, PF₃, PF₅, AsF₃, AsF₅, He, N₂, O₂, F₂, Xe, Ar, Kr, CO, CO₂, CF₄, CHF₃, CH₂F₂, CH₃F, NF₃, COF₂, as well as mixtures of two or more of the foregoing, etc., having utility in semiconductor manufacturing operations as halide etchants, cleaning agents, source reagents, etc. Other reagents which may be thus stored and delivered include gaseous organometallic reagents used as precursors for metalorganic chemical vapor deposition (MOCVD) and atomic layer deposition (ALD).

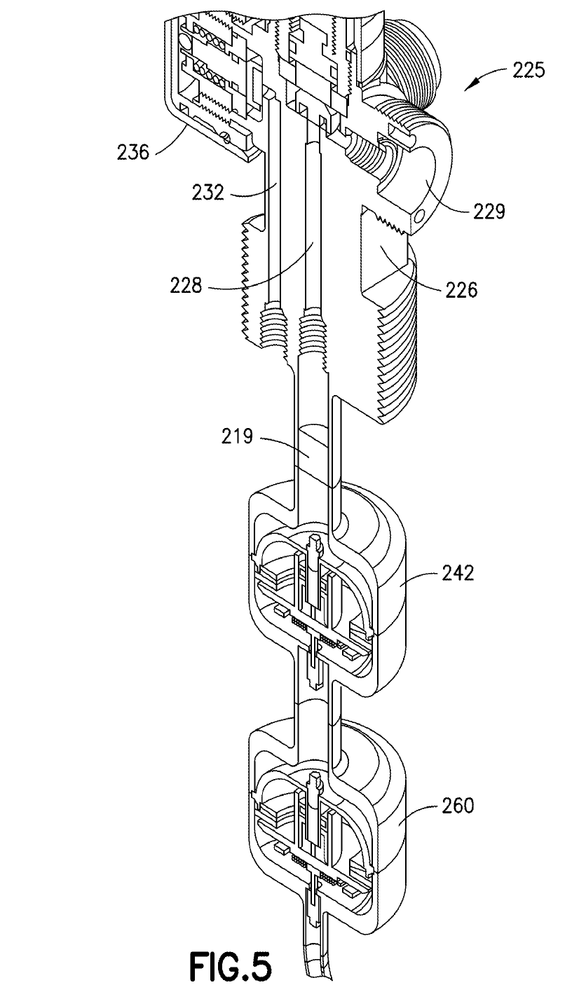

FIG. 5 is a cross-sectional perspective view of a fluid dispensing assembly of a fluid supply package of the type shown in FIG. 1, wherein the pressure management adsorbent is disposed downstream of the upper pressure regulator in the assembly.

As shown in FIG. 5, the valve head 225 comprises a fluid discharge port 229 coupled to a valve chamber of the valve head body 226. The valve chamber in turn communicates with a central vertical passage 228 of the valve head when the valve head valve (element 227 in FIG. 1) is opened by corresponding manual manipulation of the valve actuator 238 (hand wheel or pneumatic actuator) shown in FIG. 1.

In the tubular passage above the body of upper regulator 242 is disposed a pressure management adsorbent 219 that is of cylindrical form, being positioned in the tubular passage so that the flow of the dispensing fluid is required to pass through the porous adsorbent. By such arrangement, the adsorbent, which has sorptive affinity for the fluid stored in and being dispensed from the fluid supply package, will dynamically adsorb and desorb the fluid in a manner that will hydrodynamically damp the fluid flow stream and combat pressure oscillations or other anomalous flow phenomena that may occur during the dispensing operation, e.g., when the valve actuator is rotated to open the valve in the valve head to initiate dispensing operation.

The adsorbent 219 in the fluid dispensing assembly shown in FIG. 5 may be positioned in the tubular passage by press-fit positioning, or in other appropriate manner, e.g., the tubular passage may be provided with a circumferentially extending, radially inwardly protruding support element, as a circumferential flange in the tubular passage for supporting the adsorbent body thereon. The adsorbent body may alternatively be bonded on its outer cylindrical surface to the inner wall surface of the tubular passage, using an appropriate sealant, adhesive, or bonding medium. As a still further alternative, the adsorbent body may be formed in situ in the tubular passage from an adsorbent precursor material that is deposited and cured in the tubular passage to provide the adsorbent in a suitable position for subsequent use.

The fluid dispensing assembly shown in FIG. 5 further includes a lower regulator 260, which as previously described may have a pressure set point that in relation to the set point of the upper regulator 242 provides a high level of operating safety in the storage, transport, and dispensing of fluid from the fluid supply package in which the fluid dispensing assembly is installed.

The valve head 225 further comprises a fill port cap 236 that allows access when the cap is removed to the fill coupling that in turn is coupled with fill passage 232, as previously described.

The fluid dispensing assembly shown in FIG. 5 therefore provides an arrangement of components that is highly effective in providing a reduced fluid pressure stream of pressure-controlled fluid that has enhanced resistance to sudden flow perturbations and pressure excursions, relative to a corresponding fluid dispensing assembly lacking the pressure management adsorbent.

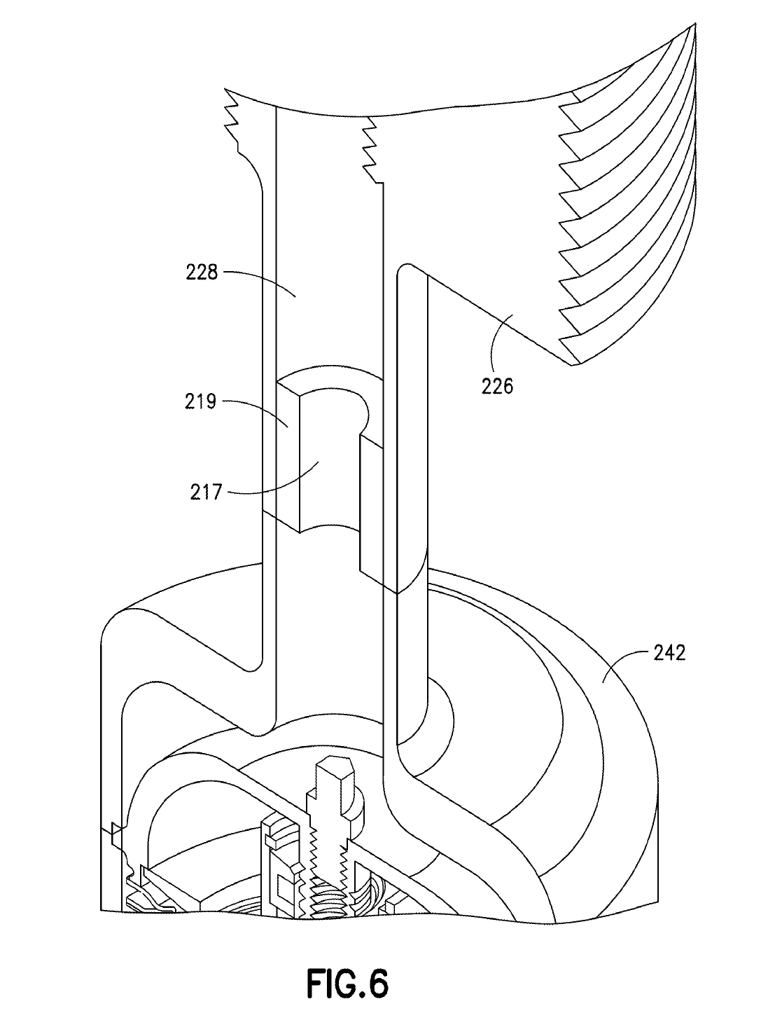

FIG. 6 is a cross-sectional perspective view of a fluid dispensing assembly of a type as shown in FIG. 5, as adapted for installation in a fluid supply package of the type shown in FIG. 1, but wherein, in contrast to the solid cylindrical adsorbent body of the adsorbent in the FIG. 5 fluid dispensing assembly, the pressure management adsorbent 219 in the FIG. 6 fluid dispensing assembly has an annular form providing a central bore passage 217 through which fluid can flow and contact the adsorbent during fluid dispensing operation. Apart from such central bore passage feature, all parts and elements in the FIG. 6 fluid dispensing assembly are numbered correspondingly with respect to the same parts and elements in FIG. 5.

The central bore passage 217 in the adsorbent 219 shown in FIG. 6, in relation to the solid cylindrical form of the adsorbent in the fluid dispensing assembly of FIG. 5, provides a lower pressure drop configuration, with higher flow conductance, but wherein the fluid being dispensed still is brought into intimate contact with the adsorbent, so as to provide sorptive damping of the fluid flow stream to at least partially attenuate flow fluctuations and oscillations that may interfere with the fluid dispensing operation, or the efficiency or reliability of the fluid-utilizing equipment that is coupled in fluid-receiving relationship to the fluid supply package.

Rather than a single central bore passage as is utilized in the adsorbent as shown in FIG. 6, the adsorbent may be provided with a multiplicity of fluid flow passages through the adsorbent body, e.g., in a regular array of such passages in the adsorbent body.

It will therefore be appreciated that the adsorbent in the fluid flow path of the fluid supply passage may be provided at one or more than one locations in or in communication with the fluid flow path, and that when provided at multiple locations, the adsorbent at the respective locations may be the same as or different from the adsorbent at other locations. It will also be appreciated that the adsorbent may be a composite material comprising two or more different adsorbent species so that the composite material is “tuned” to a specific fluid as regards its sorptive affinity for such fluid.

While the disclosure has been set out herein in reference to specific aspects, features and illustrative embodiments, it will be appreciated that the utility of the disclosure is not thus limited, but rather extends to and encompasses numerous other variations, modifications and alternative embodiments, as will suggest themselves to those of ordinary skill in the field of the present disclosure, based on the description herein. Correspondingly, the invention as hereinafter claimed is intended to be broadly construed and interpreted, as including all such variations, modifications and alternative embodiments, within its spirit and scope.

1. A fluid supply package comprising a pressure-regulated fluid storage and dispensing vessel comprising a fluid dispensing flow path, and adsorbent disposed in the flow path or in fluid communication therewith to reversibly adsorb fluid from the flow path for pressure stabilization of fluid dispensed from the vessel.

2. The fluid supply package of claim 1, wherein the fluid dispensing flow path contains at least one pressure regulator device, set pressure valve, or vacuum- or pressure-activated check valve.

3. The fluid supply package of claim 1, wherein the fluid dispensing flow path contains two pressure regulator devices in series.

4. The fluid supply package of claim 1, wherein the fluid dispensing flow path contains a vacuum-activated check valve.

5. The fluid supply package of claim 4, comprising a capillary flow restrictor upstream of the vacuum-activated check valve in the fluid dispensing flow path.

6. The fluid supply package of claim 1, wherein the fluid dispensing flow path contains a pressure regulator device including a poppet valve element in a pressure-responsive mechanism.

7. The fluid supply package of claim 1, adapted to dispense fluid at subatmospheric pressure.

8. The fluid supply package of claim 1, wherein the fluid dispensing flow path contains a pressure regulator device having a subatmospheric pressure set point.

9. The fluid supply package of claim 1, wherein the adsorbent is selected from the group consisting of silica, alumina, aluminosilicates, molecular sieves, carbon, polymers and copolymers.

10. The fluid supply package of claim 1, wherein the adsorbent comprises carbon.

11. The fluid supply package of claim 1, wherein the adsorbent comprises nanoporous carbon.

12. The fluid supply package of claim 1, wherein the adsorbent comprises a solid-phase physical adsorbent.

13. The fluid supply package of claim 12, wherein the solid-phase physical adsorbent is in a form selected from the group consisting of particulate forms, granular forms, powder forms, and monolithic forms.

14. The fluid supply package of claim 1, wherein the adsorbent has a cylindrical form.

15. The fluid supply package of claim 14, wherein the adsorbent has at least one fluid flow passage therethrough.

16.-57. (canceled)

58. A fluid supply package comprising a pressure-regulated fluid storage and dispensing vessel, a valve head adapted for dispensing of fluid from the vessel at an outlet of the valve head, flow circuitry defining a flow path for flow of the fluid from an interior volume of the vessel through a pressure-regulating assembly in the flow path to the outlet of the valve head, and adsorbent disposed in the flow path or in fluid communication therewith to reversibly adsorb fluid from the flow path for pressure stabilization of fluid dispensed from the vessel.

59. A fluid supply package comprising a pressure-regulated vessel including a pressure regulator therein upstream of a discharge port of the vessel, and adsorbent that is arranged to suppress pressure oscillations in dispensing operation of the fluid supply package.

60. The fluid supply package of claim 59, wherein the adsorbent comprises carbon adsorbent.

61.-113. (canceled)
